(19) United States
(12) Patent Application Publication
(10) Pub. No.: US 2004/0137201 A1
(43) Pub. Date: Jul. 15, 2004

(54) Method for creating a colored, engraved mark on a brick

(76) Inventors: Phyllis A. Hannan, Hermann, MO (US); Oleksandr Pozdin, Hermann, MO (US)

Correspondence Address: Glenn K. Robbins II, Greensfelder, Hemker & Gale, P.C., 2000 Equitable Building, 10 South Broadway, St. Louis, MO, 63102, US

(21) Appl. No.: 10/719,617

(22) Filed: Nov. 21, 2003

Related U.S. Application Data
(60) Provisional application No. 60/428,309, filed on Nov. 22, 2002.

(51) Int. Cl. H01S 3/00; B23K 26/00; B28B 11/08

(52) U.S. Cl. 428/172; 264/246; 264/293; 264/482; 264/400; 264/154

(57) ABSTRACT

The invention comprises a method for providing a multi-colored, long-lasting engraved mark on the surface of a brick or other similar ceramic object. Masks are used to separate coloring agents during the engraving process such that variegated designs may be created. A groove may be placed in the surface of the brick over the area to be engraved to provide a substratum for the coloring agent. The coloring agent is placed in the groove and subjected to heating such that it melts and fuses with the underlying brick surface within the groove. The coloring agent is comprised of colored glass frit particles. A laser is optimally used for providing both the grooving and the heating steps.

### RELATED APPLICATION

This application claims the priority benefit of U.S. Provisional Application No. 60/428,309, filed Nov. 22, 2002.

### BACKGROUND OF THE INVENTION

The invention relates to the field of engraving alphanumeric characters or other artistic designs or figures on bricks, stones, monuments and the like. The demand for creating a long lasting inscription on an object to be used as a memorial, tribute or other source of recognition is tremendous. A popular means of fundraising to subsidize the construction of a civic building or walkway is the selling of personalized bricks on which the donor's name is engraved. Frequently, these bricks are integrated into an exposed wall or walkway so that the donor's name can be viewed. Since the bricks are exposed to environmental elements and are subject to being touched and rubbed, it is critical that the engraving be sufficiently long-lasting and durable. Current methods for engraving generally produce very good results. Such methods include first creating a groove or channel in the brick by sand blasting, mechanical grinding and chemical etching, and following up with filling the grooves with paint. The paint, however, is subject to degradation and wearing away over time.

Another method for producing engraved markings on bricks is by applying a laser to the surface of a brick so as to effect vitrification, or melting, of the top surface of the brick material along the area comprising the alphanumeric character or artistic design. An example of this method is described in U.S. Pat. No. 5,554,335 wherein the application of the laser to the brick produces a heating effect to melt, or vitrify, the brick material to produce a contrasting, long lasting, glass-like mark. The produced mark is generally black in color, although other colors may result. Thus, while the laser-produced mark is quite aesthetically pleasing, its resultant color is limited and often unpredictable, being dependent upon the particular chemical composition of the subject brick, such as the type of brick, and the concentration of silicates and other materials.

U.S. Pat. No. 6,075,223 discloses a method of laser marking metals, plastics, ceramic materials and glass which comprises applying to the material to be marked a layer of marking material which is then irradiated with a laser along an area forming the desired mark to effect a bonding of the material to the surface of the workpiece. Similarly, U.S. Pat. No. 6,238,847 discloses a method of laser marking substrates such as glass, ceramic, metal and plastic by applying a marking material to the surface of the substrate, followed by irradiation of a portion of the marking material to form a permanent marking on the substrate. The non-irradiated portion of the marking material is removed from the substrate leaving the desired mark. In each of these patents, the marking material includes glass frit particles which can be colored, thus leaving a colored mark on the surface of the substrate. U.S. Pat. No. 6,635,846 discloses the use of a sealed colorant package to hold the colored glass frit, or other marking material, in a modification to the methods of the two patents described above.

There is a great demand and need for a method for creating an engraved brick where the markings are colored. Such a method would be especially desirable in situations where multiple colors of the intended marking has a special significance, such as the colors of an institution, athletic team or other organization. Frequently, the designs signifying organizations have variegated coloring, making it difficult to produce a multi-colored marking when the marking material is comprised of glass frit or some other loosely bound compound. This makes it extremely difficult to achieve a neat and precise separation of colors. The laser engraving methods described above are unsatisfactory for producing anything other than a single contiguous color. Thus, they are not well-suited to meet the market demand for creating a multi-colored laser-engraved mark on a brick or other ceramic substrate.

### SUMMARY OF THE INVENTION

By means of the instant invention there is provided a method for creating a colored, engraved marking on a brick, and further, a method for creating a multi-colored engraving. The marking may comprise an alphanumeric character or any other design, logo or shape. The method comprises melting a coloring agent, such as colored glass frit, over a localized area on a brick's surface that is coextensive with the area comprising the desired alphanumeric character or artistic design. The underlying brick surface is also melted to a degree so the glass frit solidifies and bonds with it upon cooling, leaving a permanent colored mark in the surface of the brick. To achieve a more robust, longer lasting mark, a groove is first created in the brick surface over the precise area that will be engraved. This provides a more substantial substrate upon which the coloring agent may bond and also helps to provide an improved contrast of the engraved mark to the surrounding brick.

Glass frit, various metal and dielectric oxides, and even pulverized brick particles can be used as the coloring agent. A number of different heat sources may be used to melt the coloring agent on to the brick. A localized heat source, such as a laser, is most effective for melting the coloring agent as it can apply heat directly, and only, to the area to be marked. A laser is further beneficial in that it can be programmed to first create a groove in the brick, then melt the coloring agent, which steps can be done in quick sequence by a single piece of equipment without having to move or reposition the brick.

Glass frit is commercially available in various colors, and the particular color of frit applied will usually correspond directly to the resultant color of the finished marking. Another coloring agent may comprise brick powder, which can be obtained by crushing brick material. Various bricks have different chemical compositions which can produce a variety of colors upon melting when one type of brick is used as the substrate and another is used for the coloring agent.

A preferred embodiment of the invention comprises a process by which multiple colors may be placed in contiguous proximity to each other in the region of the desired marking. A groove may be first cut into the brick surface in the region of the marking, or alternatively, the marking may be placed directly on the brick surface without a groove. Colored glass frit is used as the marking material, and any combination of colors may be used. In order to maintain a separateness of the colors and prevent spilling of one color region in the marking to another color region, the deposition and laser melting of each color is done sequentially. A plurality of mask members are sequentially laid down over the brick surface, each of which permit the deposition of specific colored glass frit corresponding to the color and configuration of its particular region of the desired marking. In this fashion, a variegated colored marking for any conceivable shape and design may be created on the surface of a brick.

It is therefore an object of the invention to provide a method by which a colored marking may be engraved onto a brick.

It is a further object of the invention to provide a method by which multiple colors may be engraved onto a brick using colored glass frit or other suitable marking material.

It is a further object of the invention to provide a method by which a variegated multi-colored marking may be engraved onto a brick using colored glass frit or other suitable marking material.

The above features are objects of this invention. Further objects will appear in the detailed description which follows and will be otherwise apparent to those skilled in the art.

For purpose of illustration of this invention, a preferred embodiment is shown and described hereinbelow in the accompanying drawing. It is to be understood that this is for the purpose of example only and that the invention is not limited thereto.

### DESCRIPTION OF THE DRAWINGS

FIG. 1 is a cross-sectional view in side elevation of a portion of a brick in which a groove for forming the substratum for placing the coloring agent is cut.

FIG. 2 is a cross-sectional view in side elevation of the brick from FIG. 1 in which coloring agent is placed into the groove.

FIG. 3 is a cross-sectional view in side elevation of the brick from FIG. 1 showing the coloring agent being melted by a localized heat source.

FIG. 4 is a cross-sectional view in side elevation of the brick from FIG. 1 showing the resultant bonding of the coloring agent to the surface of the brick within the groove.

FIG. 5 is a perspective view of a finished brick engraved by the inventive process.

FIG. 6 is a schematic view of a multi-colored design engraved into a brick and the masking elements used to create the integrated colored marking.

FIG. 7 is a schematic view of a first mask placed over the brick to create a first portion of the variegated colored mark.

FIG. 8 is a schematic view of the brick surface after the first colored portion of the design has been engraved into the brick.

FIG. 9 is a schematic view of a second mask placed over the brick to create a second portion of the variegated colored mark.

### DESCRIPTION OF THE INVENTION

By means of the instant invention, a process is provided for engraving a brick or other ceramic-type surface with a colored marking that is both attractive, durable and long-lasting. A coloring agent is placed within an area on the brick surface comprising an alphanumeric character or design element that is to be engraved and is locally heated at that area to the extent that it is melted and fused into the surrounding brick surface.

A preferred coloring agent contemplated by this invention comprises colored glass frit particles. Glass frit is commercially available and comes in a wide variety of colors. The methods of producing colored glass frit are well known to those skilled in the art and form no part of the invention per se. It is commonly used in making stained glass windows and other artistic creations. Glass frit comes in a variety of particle sizes, ranging from coarse to medium to fine. While all grades can produce relatively acceptable results under the invention, the smaller particles, with a small volume-to-surface area ratio, melt most evenly and efficiently, and are preferred. The particle size of the glass frit is optimally within the range of less than 1 millimeter and greater than 10 microns in diameter.

Glass frit particles may be comprised of quartz, silicon dioxide and various other metal and dielectric oxides, including the elements of aluminum, potassium and boron among others. Colored glass frit is available in practically all colors, which are derived by adding additional elements. For example, blue colored glass frit is produced by adding cobalt oxide when forming the glass. Bricks themselves are formed of various compounds which, when oxidized and melted, may produce distinct colors. Accordingly, brick that has been pulverized into a powder may even be used as a coloring agent. Bricks come in many different shades, ranging from bright red to white. Red bricks have a high ferrous oxide (FeO) content which produces a dark color when melted. This type of brick may yield a final colored mark that is darker than the original color of the coloring agent applied to it. Lighter shaded bricks, in contrast, typically have a higher alumina content, and their color is relatively unaffected when they are melted. Accordingly, when selecting a brick for colored engraving under the process of this invention, the presence of ferrous oxide in the brick and its effect on the color of the resultant engraving should be considered. Also, some types of coloring agents yield a different hue after heating and melting than their original color. Thus, some trial and error for such coloring agents may be required.

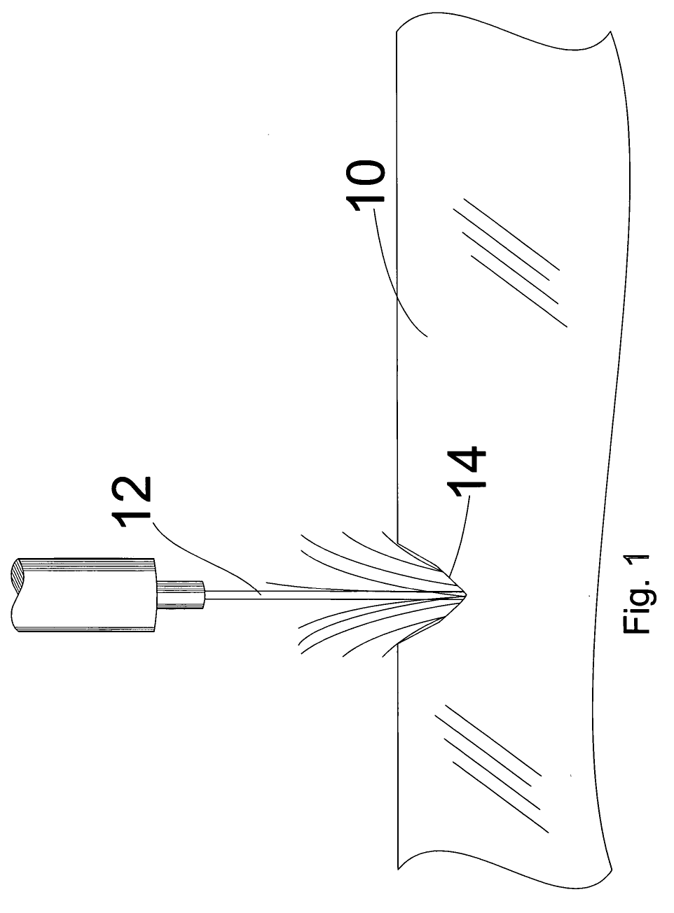

In preparing a colored engraving under a preferred embodiment of the inventive process, a brick is first provided with a groove or channel along the particular area forming the font, design or logo. The complete area comprising the precise font shape of the alphanumeric character or entire design element is grooved (its outline and interior region), as it will form the substratum on which the coloring agent will be bonded. The substratum groove may be cut into the brick by a number of known methods, such as chiseling, sandblasting or chemical etching. These methods, while acceptable, require a further and separate setup, as well as additional equipment, for heating the coloring agent that is placed into the substratum groove. The use of laser apparatus for the overall engraving process is advantageous because the laser may be dually programmed for both the initial grooving step and subsequent step of melting the coloring agent without moving or adjusting the brick from the work area. FIG. 1 shows the brick 10 being ablated by a laser beam 12 to produce the groove 14 (not drawn to scale). The depth of the groove should be at least as great as that of the diameter of the glass frit particle size used (which may be as small as 10 microns) to more readily retain the particles therein so that the frit does not scatter when the heating source is introduced thereto. For greater contrast and for enhanced durability of the mark, the depth of the groove may be increased. A greater depth not only provides a recessed marking, which withstands physical and environmental factors better, but also provides a larger reservoir to hold a greater concentration of glass frit particles during the melting phase.

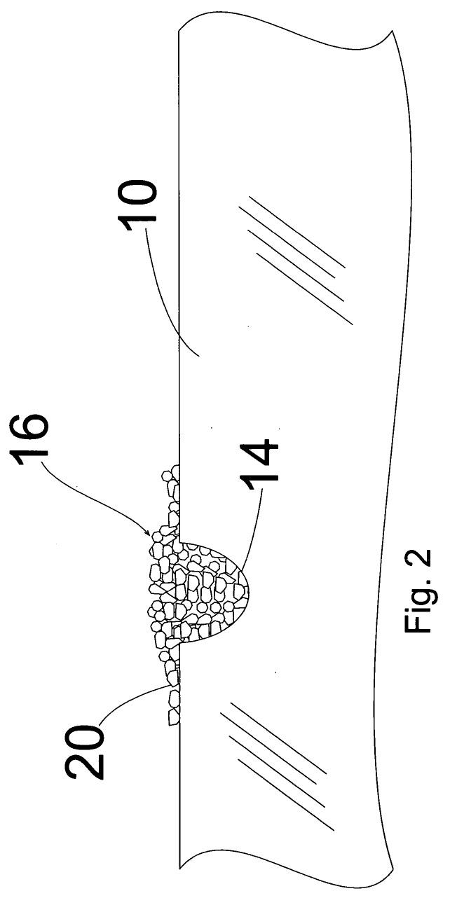

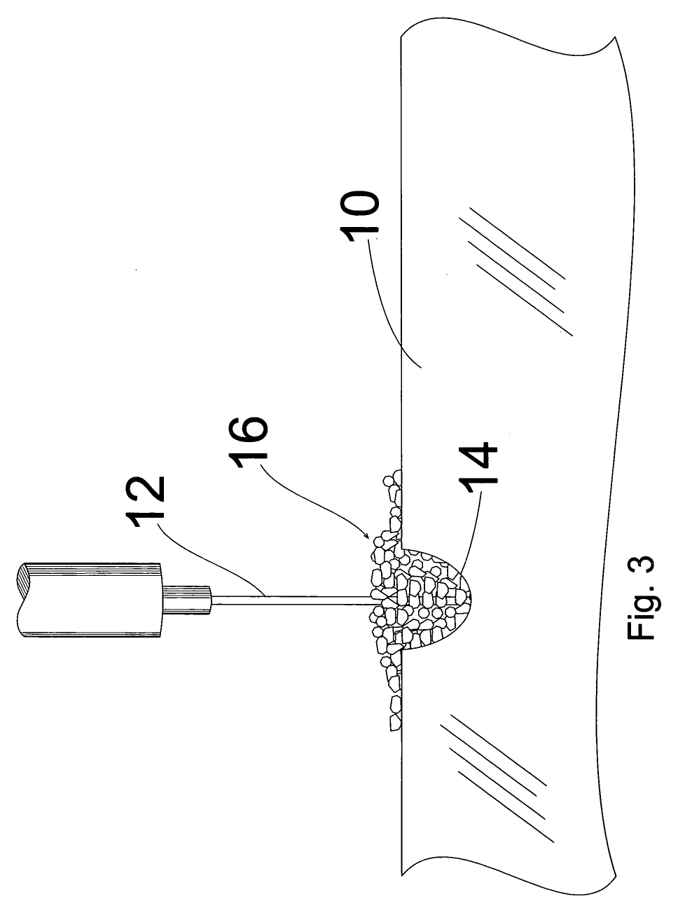

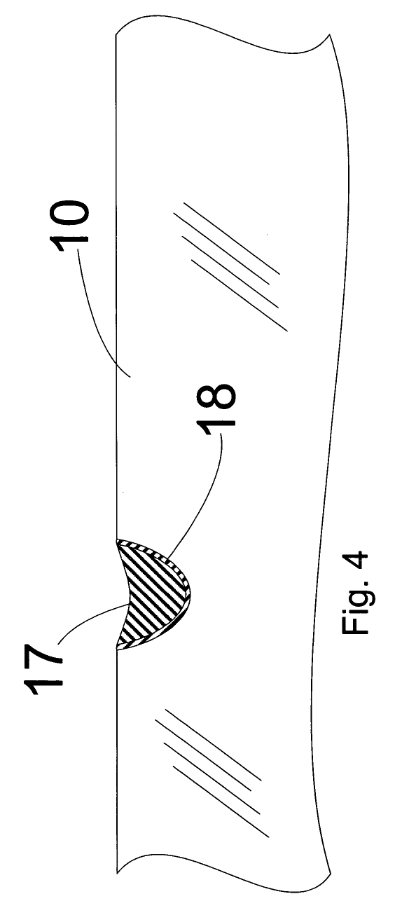

After groove 14 has been cut into brick 10, a coloring agent 16 is spread over the entire area comprising the mark to be engraved as shown in FIG. 2. An amount of coloring agent 16 sufficient to completely fill groove 14 should be provided. The amount of coloring agent placed in the groove should be maximized to produce the strongest coloring effect. Excess unmelted coloring agent 20 may be wiped away from the surrounding area after the process is complete. A localized heat source, such as a laser 12, is applied to the coloring agent to melt it so that it fuses with the surrounding brick material in groove 14 as shown in FIG. 3. A layer of brick 18 within groove 14 is also melted, enabling melted coloring agent 17 to fuse with brick layer 18 within the groove as shown in FIG. 4. Other forms of localized heat sources that can be applied specifically and directionally may be used to melt the coloring agent, such as directional microwave heating devices. A factor that affects the heating efficiency is the glass frit particle size. Large particle sizes require greater energy to melt, while finer particles are more easily melted. Upon cooling, an attractive, colorized mark approximating the color of the original glass frit is produced within the groove on the surface of the brick.

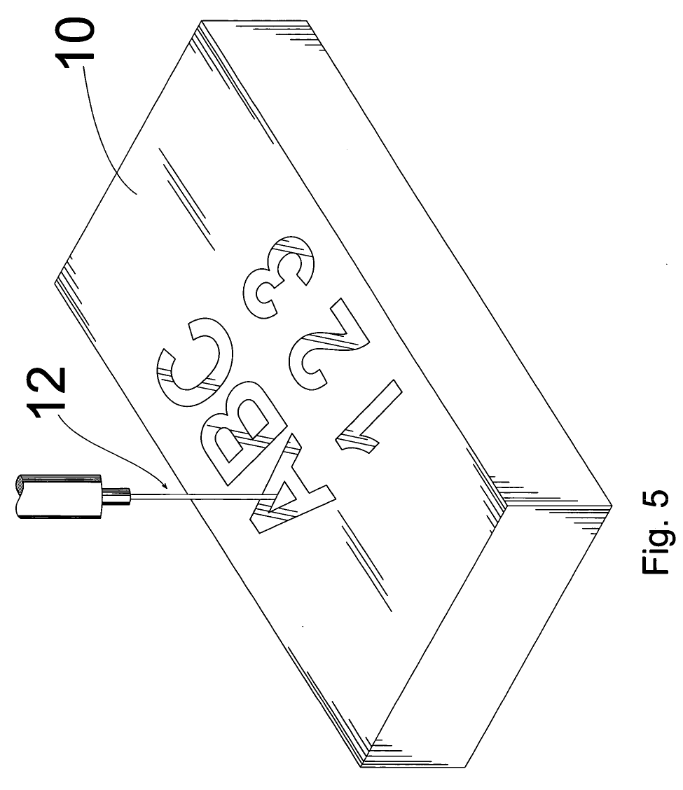

A laser is preferably used for creating both the initial groove in the brick and also for producing the localized, directional heat source to melt the coloring agent specifically within the groove. The laser can be programmed for different power settings sufficient to ablate the brick in a first laser run and then followed up with a heating run to melt the coloring agent as depicted in FIG. 5, all without having to reposition the brick between runs. The laser can be programmed to create any design imaginable. Ablation and heating are dependent upon the power of the laser. Various types of lasers have the necessary power requirements for achieving both the ablation and melting steps, including CO₂, semiconductor lasers stack and YAG lasers and persons having skill in the art would understand the various lasers' operational capabilities. As one example, the YAG laser may be operated in continuous wave (CW) or Q-switch mode in the power range of 60 to 200 Watts, with up collimator 2-8 and F-Theta lens with focal lens 160 to 250 mm. For creating the groove in the brick, the Q-switch is optimally set for ablation in the low kHz range (under 20,000 Hz). To melt the coloring agent, the laser is preferably set to CW mode or a high repetition rate (20,000 to 50,000 Hz or greater). Different batches of glass frit material from different manufacturing sources may have different melting temperature ranges, which may require a different amount of applied heat sufficient to cause melting. Although this may require some degree of trial and error, varying the linear speed of the laser's galvo speed, as understood by those having ordinary skill in the art, will effectively enable appropriate adjustment to permit melting.

It is further possible with the process of the invention to prepare a multi-colored engraving, which can be done in the same two-step process, in certain circumstances, without the need for separate runs. The groove-creating step and heating step are performed in substantially the same manner regardless of the number of different colors used. It is desirable to provide a separation barrier of the various coloring agents within the groove areas corresponding to the desired respective color for that area as further discussed below. For discrete characters or designs, which have separate, non-contiguous grooved areas on the brick surface, it is a simple matter to segregate the different respective coloring agents within their respective grooved areas. This would be the situation where a first line of alphanumeric characters would be a different color from a second such line, where a separate design element was used with alphanumeric characters, or where distinct and separate, non-contiguous design regions form the marking area.

Another embodiment for creating multi colored engraving employs a masking or stenciling process. This process uses masks or stencils to apply multiple coloring agents each to specific areas on the surface of the brick corresponding to each of the colors of the desired multi-colored design. Because brick engraving is a popular means for organizations to raise money or honor its members, it may be desirable for an organization to provide personally engraved bricks for its individual members. The engravings on such bricks may comprise both an organizational design and a personal message, such as an individual's name or a brief tribute. The organizational design would likely be a common element appearing on all the members' bricks, while each individual brick would likely have a unique personalized design or name of the member.

The mask used to create the common multi-colored design element would desirably be made of a material that could withstand the rigors of high repetition. Accordingly, a stainless steel mask may be produced for this purpose. The stainless steel mask may be created by chemical etching or other methods known to those having skill in the art. Its advantage is that it delivers constant quality over high repetition and requires minimal cleaning and maintenance. If the text or artwork comprising the engraving on a brick is unique, and the mask is likely to be used only once or for a very limited number of times, it may be more practical to produce a new mask for each color run. For this purpose, the mask may be made from a less costly material, such as a polymer film like Mylar® or Kapton®. The mask should be of sufficient size to incorporate the respective color region of the design it represents and to enable it to be secured to the surface of the brick. The mask may be held in place on the brick by taping or other appropriate means.

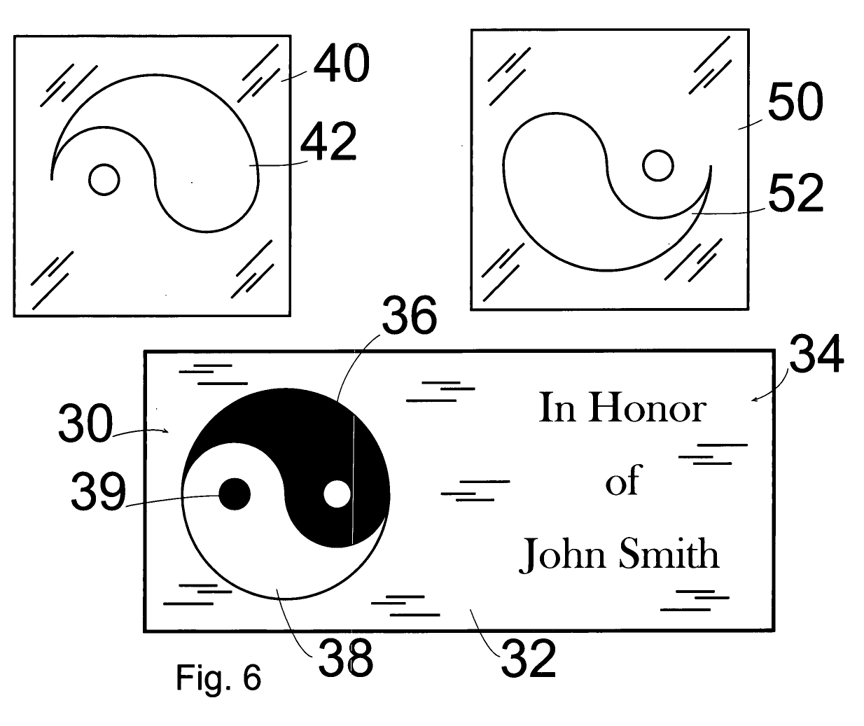

Separate and sequential mask runs are employed where a design to be engraved has multiple colors integrated into a contiguous area comprising the engraving. For purposes of explanation, the yin-yang symbol 30 is referenced in FIG. 6 as the proposed design, which is showed as engraved on a brick 32 in combination with a text inscription 34. Assuming the black and white portions 36 and 38 of symbol 30 represent respective colored portions of the marking to be engraved (which can be any color), it can be seen that it would be difficult to separate the colors and create borders effectively without some form of masking. While a binding agent might be added to the glass frit particles to reduce their flow outside their designated region in the marking, it would not provide an edge with the precision and crispness that a mask would provide.

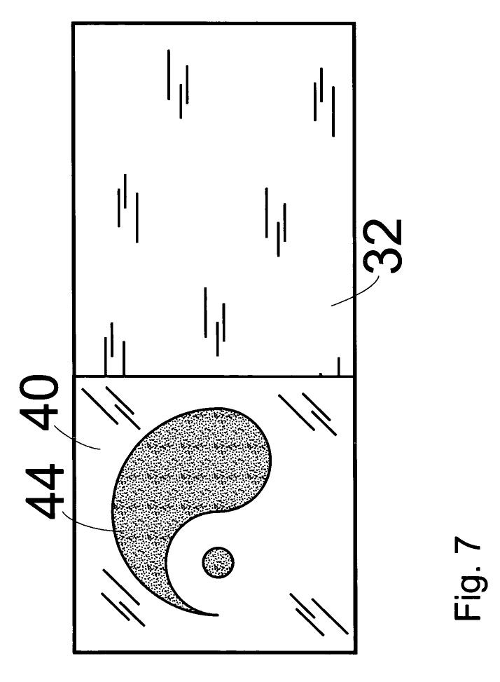

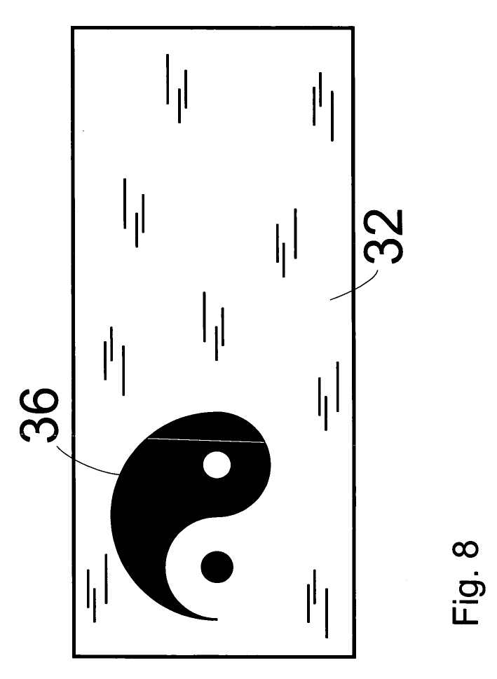

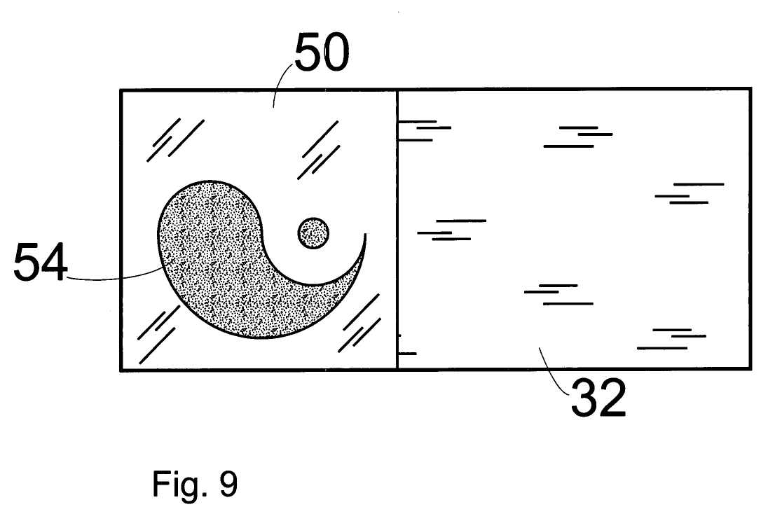

For a variegated, multi-colored design, an initial step of the engraving process is to create pattern of grooves and channels over the area of the desired artwork on a brick surface, as discussed above and shown in FIG. 1. In a subsequent step (shown in FIG. 7), a first mask 40 is placed and secured over brick 32 in alignment with the grooved design 30 just created. First mask 40 is provided with an opening 42 which corresponds to black colored portion 36 of design 30. Glass frit particles 44 are placed in mask opening 42 and subjected to the laser. Upon melting of the glass frit particles 44, mask 40 is removed leaving the black colored portion 36 engraved in the top surface of the brick as shown in FIG. 8. The mask very effectively provides a neat, defined edge which clearly demarcates and separates the color regions of the marking. In a further subsequent step, a second mask 50 is placed and secured over brick 32 in alignment with the grooved design 30, as shown in FIG. 9. Second mask 50 is provided with an opening 52 which corresponds to white colored portion 38 of design 30. Glass frit particles 54 are placed in mask opening 52 and subjected to the laser. Upon melting of the glass frit particles 54, mask 50 is removed leaving the white colored portion 38 engraved adjacent to, and continuous with, the black colored portion 36 in the top surface of the brick as shown in FIG. 6. The colored glass frit may be added to the text portion 34 during either of the runs. Because the text portion is likely to be of a single color, the masking process would not be necessary for its creation. It is to be understood that a separate mask is desirable for each color in an integrated, variegated colored mark, although the mask can be created such that it can accommodate the entire area of the desired mark comprising that color. For instance, the outline of solid circle 39 is also provided in mask 40.

Stainless steel masks can be separately produced in advance of the engraving process and used over and over. In contrast, if a polymer film or other similarly disposable material mask is used, it may be created at the time of engraving, concurrently with the grooving step. A new and uncut piece of polymer film is placed down over the area to be engraved. The laser can ablate both the polymer and underlying brick material during the same pass. Only that area of the design corresponding to a particular color portion is engraved for any particular mask. After grooving with the first mask, and while the mask is in place, the colored glass frit corresponding to that mask is added and melted. When that step is complete, the first mask is removed from the brick surface, leaving the first engraved color portion, and carrying away any loose glass frit particles. The cut polymer mask may then be discarded. The above steps are repeated with as many masks as necessary to create the remaining colors of the design, with a separate, new mask being used for each desired color.

Preferred Embodiment

It is to be understood that a wide variety of coloring agents may be employed in the inventive process as described above, and that various groove-producing and heat applying sources may be used to bring about the results of the invention. One specific example for carrying out the engraving process is herein described.

The subject pattern for engraving is first selected, which may comprise any combination of alphanumeric characters or any design element or logo. One or more colors for the engraving are selected and an appropriate colored glass frit approximating that color is obtained. An appropriate brick on which to engrave the colored mark is selected. To avoid an off-setting, dark color which may interfere with the desired and anticipated resultant color engraving produced by the selected colored glass frit, a brick having a low ferrous oxide content is selected for marking. One such suitable brick is of the grade designation Shade 50, which is an ivory colored brick. A YAG laser is selected for carrying out the grooving and melting phases. As is well known in the art, this type of laser may be programmed to properly steer the focused laser beam for multiple runs with variable operating parameters. For the groove-creating step, the laser current is set to 22 amps, the repetition rate to 2500 Hz and the galvo speed to 10 mm/sec. These parameters are effective for machining alphanumeric characters into the brick surface. If a design element, such as artwork, graphics or logos are desired, the galvo speed is set to 20 mm/sec. To ensure that the groove is sufficiently ablated, two passes of the laser over the area to be grooved may be made. Alternately, one pass of the laser may be sufficient if a lesser depth is desired, or three or more passes may be made if a deeper mark is desired. The depth of the groove affects the contrast of the color of the engraved mark. With a greater depth, more glass frit particles can be used for preparing the mark. As the density of colored glass frit particles within the groove increases, it creates a more concentrated color. Next, the grooves are filled with glass frit particles having the desired color pigment. Subsequently, the laser parameters are set in preparation of the heating and melting phase. The frequency of the laser is set to continuous wave (CW), with a current of 22 amps and galvo speed of 3 mm/sec if alphanumeric characters comprise the mark to be engraved. If the engraved mark comprises a design element or graphics, the galvo speed is set to 20 mm/sec. The programmed laser beam passes over the glass frit in the pattern, heating it to a sufficient degree to cause it and an underlying brick layer to melt and fuse together. One pass of the laser over the grooved area is sufficient. The laser beam focus is limited to the precise area forming the subject pattern and avoids spill over beyond the outline border of the engraved image. The brick is then allowed to cool, leaving a colored, vitrified mark as the engraved image. Excess colored glass frit lying outside the outline border of the engraved image, which remains untouched and unmelted by the laser beam, is simply wiped away.

Various changes and modifications may be made within this invention as will be apparent to those skilled in the art. Such changes and modifications are within the scope and teaching of this invention.

What is claimed is:

1. A method for creating a multi-colored engraving having contiguous color regions on a ceramic surface, said method comprising:
a) selecting a design having an area of contiguous regions comprising a plurality of different colors to be engraved on said ceramic surface,
b) selecting a first area on said ceramic surface for engaging a first color region,
c) placing a first masking member over said ceramic surface at said first area, said first masking member defining a first opening having an outline approximating a dimension of said first color region,
d) depositing an amount of a first coloring agent on said ceramic surface through said first masking member on said first area to be engraved,
e) heating and melting said first coloring agent to cause it to fuse into said ceramic surface at said first area and thereafter removing said first masking member to leave a colored engraved mark comprising a first color region in said ceramic surface,
f) selecting a second area on said ceramic surface for engraving a second color region,
g) placing a second masking member over said ceramic surface at said second area, said second masking member defining a second opening having an outline approximating a dimension of said second color region,
h) depositing an amount of a second coloring agent on said ceramic surface through said second masking member on said second area to be engraved, and
i) heating and melting said second coloring agent to cause it to fuse into said ceramic surface at said second area and thereafter removing said second masking member to leave a colored engraved mark comprising a second color region in said ceramic surface, said second color region being contiguously adjacent to said first color region.

2. The method according to claim 1 in which said coloring agent comprises colored glass frit.

3. The method according to claim 1 in which additional color regions are engraved into said marking area by placing additional masking members over said ceramic surface at said marking area, said additional masking members each defining a further opening having an outline approximating a dimension of said respective additional color region, depositing an amount of a respective additional coloring agent on said ceramic surface through said additional masking members on said area to be engraved, heating and melting said additional coloring agents to cause them to fuse into said ceramic surface at said engraved area and thereafter removing said additional masking members to leave a colored engraved mark comprising said additional color regions in said ceramic surface, said additional color regions being contiguously adjacent to at least one of said first and second color regions.

4. The method according to claim 1 in which grooves are cut into said ceramic surface at each of said areas of color regions to be engraved prior to depositing said coloring agents, whereby an exposed ceramic surface in said grooves serve as a substratum on which said coloring agents are deposited.

5. The method according to claim 4 in which said colored engraved mark has a depth extending below said ceramic surface such that said mark is recessed below said ceramic surface.

6. The method according to claim 1 in which a laser is used to heat and melt said coloring agents.

7. The method according to claim 4 in which a laser is used to cut said groove into said ceramic surface and to heat and melt said coloring agent.

8. The method according to claim 1 in which said masking members are comprised of stainless steel.

9. The method according to claim 1 in which said masking members are comprised of a polymer material.

10. A method for creating a multi-colored engraving having contiguous color regions on a ceramic surface, said method comprising:
a) selecting a design having contiguous regions comprising a plurality of different colors to be engraved on said ceramic surface,
b) selecting a first area on said ceramic surface for engraving a first color region,
c) placing a first masking member over said ceramic surface at said first area, said first masking member defining a first opening having an outline approximating a dimension of said first color region,
d) applying a laser to said ceramic surface over said first area to cut a first groove into said ceramic surface for receiving a first coloring agent,
e) depositing through said first masking member an amount of said first coloring agent in said first groove,
f) heating and melting said first coloring agent to cause it to fuse into said first groove in said ceramic surface at said first area and thereafter removing said first masking member to leave a colored engraved mark comprising a first color region in said ceramic surface,
g) selecting a second area on said ceramic surface for engraving a second color region,
h) placing a second masking member over said ceramic surface at said second area, said second masking member defining a second opening having an outline approximating a dimension of said second color region,
i) applying a laser to said ceramic surface over said second area to cut a second groove into said ceramic surface for receiving a second coloring agent,
j) depositing through said second masking member an amount of said second coloring agent in said second groove, and
k) heating and melting said second coloring agent to cause it to fuse into said second groove in said ceramic surface at said second area and thereafter removing said second masking member to leave a colored engraved mark comprising a second color region in said ceramic surface, said second color region being contiguously adjacent to said first color region.

11. The method according to claim 10 in which said colored engraved mark has a depth extending below said ceramic surface such that said mark is recessed below said ceramic surface.

12. The method according to claim 10 in which said coloring agent comprises colored glass frit.

13. The method according to claim 10 in which said masking members are comprised of a polymer material.

14. The method according to claim 13 in which said masking members are created simultaneously with the cutting of said grooves in said ceramic surface by placing a sheet of polymer material on said ceramic surface prior to cutting said groove, applying said laser over said area to be engraved to cut through said polymer material simultaneously as said laser cuts said ceramic surface, such that said openings corresponding to said color regions are created in said polymer material to produce said masking members.

15. A method for creating a colored engraving on a ceramic surface, said method comprising:
a) selecting an area to be engraved on said ceramic surface,
b) cutting a groove into said ceramic surface at said area to be engraved, whereby an exposed ceramic surface in said groove serves as a substratum on which a coloring is deposited.
c) depositing an amount of said coloring agent on said ceramic surface over said area to be engraved, and
d) heating and melting said coloring agent to cause it to fuse into said ceramic surface at said area to leave a colored engraved mark in said ceramic surface.

16. The method according to claim 15 in which said coloring agent comprises colored glass frit.

17. The method according to claim 15 in which said colored engraved mark has a depth extending below said ceramic surface such that said mark is recessed below said ceramic surface.

18. A ceramic brick having a multi-colored design engraved on its exterior surface, said colored design comprising a fusion of a plurality of coloring agents with an outer ceramic layer of said brick, said colored design comprising contiguous regions of different colors corresponding to said coloring agents.

19. The ceramic brick of claim 18 in which said coloring agent comprises glass frit.

20. The ceramic brick of claim 18 in which said colored engraved mark has a depth extending below said ceramic surface such that said mark is recessed below said ceramic surface.

21. The ceramic brick of claim 20 in which said colored engraved mark is disposed in a groove in said brick surface, said groove being created by a laser, and fusion of said coloring agent with said ceramic surface is effected by heating by laser.
